(19) United States
(12) Patent Application Publication
(10) Pub. No.: US 2015/0381784 A1
(43) Pub. Date: Dec. 31, 2015

(54) MULTI-PANEL FLIP COVER FOR A COMPUTING DEVICE

(71) Applicant: Kobo Inc., Toronto (CA)

(72) Inventor: Archer Wun, Toronto (CA)

(21) Appl. No.: 14/317,943

(22) Filed: Jun. 27, 2014

(51) Int. Cl. H04M 1/04; H04B 1/3888; H04M 1/02

(52) U.S. Cl. CPC H04M 1/04; H04M 1/0202; H04B 1/3888

(57) ABSTRACT

A flip cover for a computing device includes a base segment, a connector platform and a neck. The base segment supports the computing device. The connector platform mechanically attaches to a bottom surface of the computing device. The neck extends between the base segment and the connector platform, and the neck provides the connector platform with an ability to pivot about the bottom surface.

### TECHNICAL FIELD

Examples described herein relate to a mufti-panel flip cover for a computing device.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device assembly to display e-books and other content, according to an embodiment.

FIG. 2 illustrates an example of an e-reader device or other electronic personal display device, for use with one or more embodiments described herein.

FIG. 3A is an isometric view of an example cover for a computing device, according to an embodiment.

FIG. 3B is an isometric view of an example cover mated with a computing device, according to another embodiment.

FIG. 4A through FIG. 4C illustrate different examples of a connector surface for a connector platform of a cover, in accordance with one or more embodiments.

FIG. 5A through FIG. 5F illustrate a cover engaged with a computing device, in accordance with one or more embodiments.

FIG. 6A and FIG. 6B illustrate rear and side perspectives of an example cover that is coupled to a computing device (e.g., e-reader device), in accordance with one or more embodiments.

FIG. 6C through FIG. 6E illustrate a cover that is manipulated so that its panels are aligned linearly along a back face of a computing device, in accordance with one or more embodiments.

### DETAILED DESCRIPTION

Examples described herein include a multi-panel flip cover for a computing device. According to one aspect, the cover can include multiple panels that can pivot about an end of the computing device. In one implementation, the cover includes a connector platform that can twist or pivot from an unengaged orientation to an engaged orientation, so as to physically support the computing device.

According to one aspect, a cover includes a base segment, a connector platform and a neck. The base segment supports the computing device. The connector platform mechanically attaches to a bottom surface of the computing device. The neck extends between the base segment and the connector platform. Furthermore, the neck is structured to provide the connector platform with an ability to pivot about the bottom surface.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System and Device Description

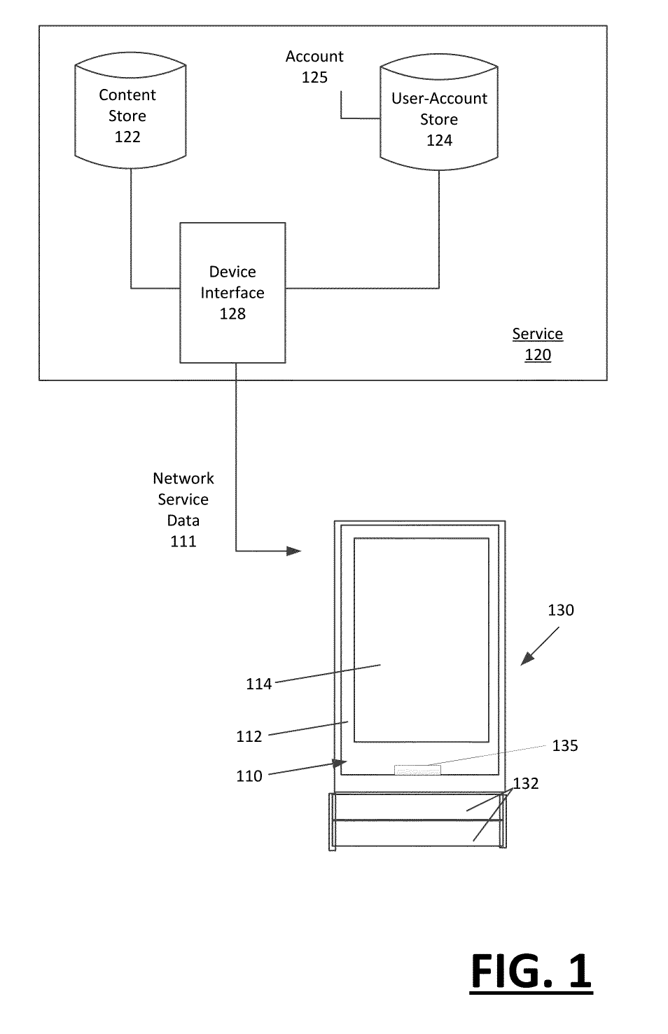

FIG. 1 illustrates a system for operating a computing device assembly to display e-books and other content, according to an embodiment. In an example of FIG. 1, the computing device assembly includes an electronic display device, shown by way of example as an e-reader device 110, and a cover 130. The cover 130 is an example of an accessory device which encloses (or at least partially encloses) the computing device in order to provide support, protection and/or privacy.

The network service 120 can communicate with the e-reader device 110 in order to, for example, deliver e-books or other forms of content items. In an example of FIG. 1, the network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 to receive network service data 111. The network service data 111 enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. With reference to FIG. 1, the e-reader device 110 includes a housing 112 and a display surface 114. The display surface 114 forms a front facade of the housing 112. In some implementations, the display surface 114 can correspond to, for example, an E-ink display.

In additional detail, the network service 120 can include a device interface 128, a resource store 122, and a user account store 124. The device interface 128 communicates with individual e-reader devices 110. In particular, the device interface 128 can communicate with individual e-reader devices in order to identify the accounts 125 of the users of such devices, and further to provide various services for downloading or enabling transactions for content items provided through network service 120. The user account store 124 can associate the particular e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

In an example of FIG. 1, e-reader device 110 is coupled to cover 130. The cover 130 can include multiple panels 132 that collectively form a base segment that is dimensioned to overlay a front or rear facade of the e-reader device 110. As described in examples provided herein, the panels 132 are positionable relative to one another and/or the e-reader device 110 in order to raise, tilt or otherwise position the e-reader device relative to a reference (e.g., perspective of the user). More specifically, the individual panels 132 can pivot with respect to one another.

In one implementation, the cover 130 includes a connector 135 that mates with a corresponding connector of the e-reader device 110. The connector 135 can provide both electrical connectivity and mechanical securement as between the e-reader device 110 and the cover 130. Still further, in one implementation, the orientation of the panels 132 can be communicated to the e-reader device 110, which in turn includes programming or logic to respond to the panel orientation. For example, when the panels 132 of the cover 130 are oriented to prop the e-reader device 110 upright, the cover can signal the orientation to the e-reader device 110, which in turn performs an operation such as adjusting a setting, or executing an application. The particular operation assigned to the panel orientation can be pre-associated. For example, if the panels 132 of the cover 130 position the e-reader device in a tilted upright mode, the programming of the computing device can assume that the device is to be used for reading. Likewise, if the panels 132 of the cover 130 are oriented flat with respect to the e-reader device, then the programming of the e-reader device 110 can switch the device into a low-power or off-state (e.g., display off).

### Hardware Description

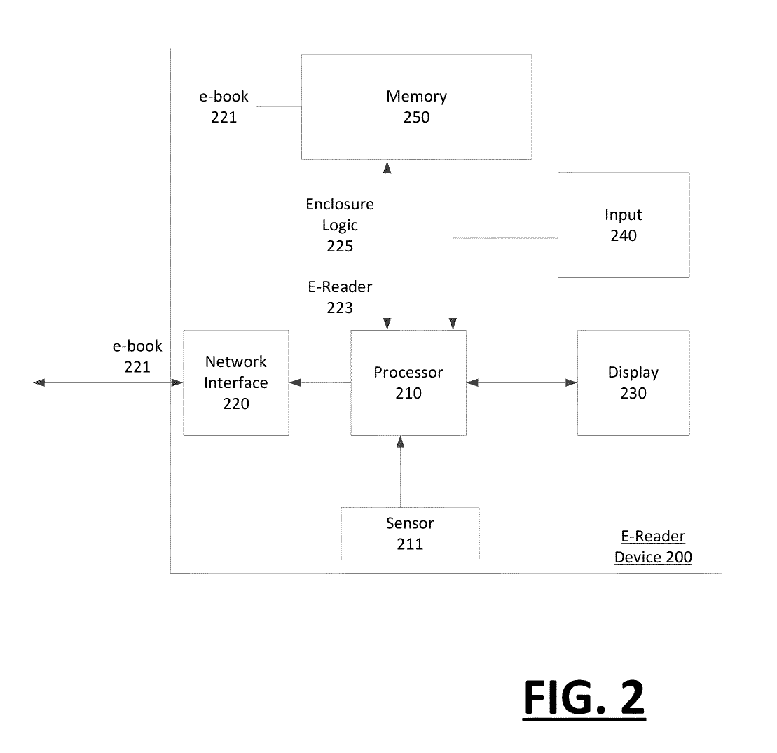

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimic conventional paper in the manner in which they display content. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices). The processor 210 can also receive input from sensors 211, including sensors that detect an orientation or configuration of the panels of the cover. In one implementation, the sensor input can trigger implementation of the trigger logic 225.

According to some embodiments, the memory 250 stores instructions 223 for implementing an e-reader component. The e-reader component can enable reading activities on, for example, display 230 (e.g., see display surface 114 of FIG. 1). Additionally, the memory 250 can store instructions that are responsive to various states of the cover (enclosure instructions 225). The enclosure instructions 225 can specify, settings or behavior of the computing device when the cover is in different states. For example, when the panels 132 are flat, the device can turn the screen off if the positioning of the panels 132 further indicates that they are overlaid on the display screen.

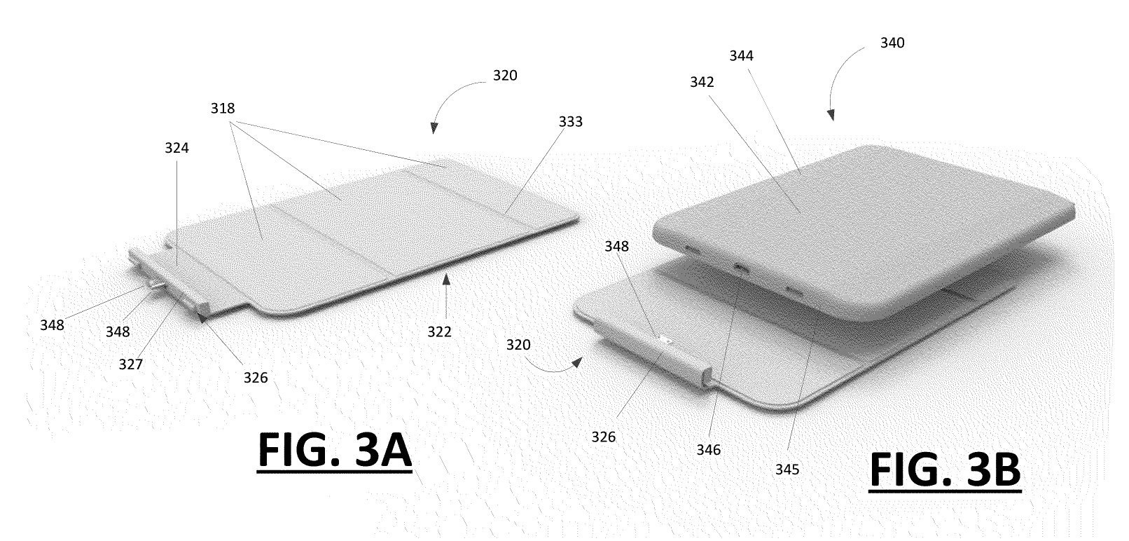

FIG. 3A is an isometric view of an example cover for a computing device such as an e-reader device, according to an embodiment. FIG. 3B is an isometric view of an example cover mated with an e-reader device, according to another embodiment. In FIG. 3A, cover 320 includes a base segment 322, a neck 324, and a connector platform 326. The base segment 322 can be formed from one or more panels 318. Each panel is constructed to be pivotable about an adjacent panel. In one construction, each panel 318 can be formed from a rigid perimeter, and the panels can be connected to one another using elastic material to form a flexible extension 333. In this way, the individual panels can use the elastic material as a connective medium to enable pivoting or other movement about an adjacent panel.

The neck 324 can be structured from flexible material to enable the connector platform 326 to swivel or pivot. As shown in an example of FIG. 3A and FIG. 3B, the neck can extend from a proximate panel 318 to the bottom surface of the computing device. The neck 324 can pivot in order to receive a bottom surface of an e-reader device 340.

According to one aspect, the connector platform 326 can pivot from a resting or natural downward position to an engaged or upright position, as shown in FIG. 3B. More generally, in an example provided, the connector platform 326 can pivot up to approximately 180 degrees. In variations, the connector platform 326 can pivot a greater or lesser amount than 180 degrees. The connector platform 326 can include mechanical and/or electrical facets on a contact surface 327. The mechanical and/or electrical facets of the contact surface 327 can (i) secure the cover 320 to the e-reader device 340, and/or (ii) electrically connect to internal electrical resources of the e-reader device 340.

With further reference to FIG. 3B, the e-reader device 340 can include a housing 342 having a back fagade 344 and a front fagade (not shown in FIG. 3B). A bottom surface 345 of the e-reader device 340 extends between the front and back fagade 344. In one implementation, the bottom surface 345 includes a connector receptacle 346 and/or mechanical securement features. As an example, the connector receptacle 346 can correspond to a female connector (e.g., mini USB connector) that receives a male counterpart connector.

The relaxed (at rest) or default orientation of the connector platform 326 can be to direct the contact surface 327, with the mechanical and electrical facets, outward away from engagement with the e-reader device 340. As shown by FIG. 3B, the neck 324 can be manually manipulated, however, to move the contact surface about 180 degrees in order to engage the bottom surface of the e-reader device 340. Once engaged, the cover 320 can be used to support, protect or cover the e-reader device 340.

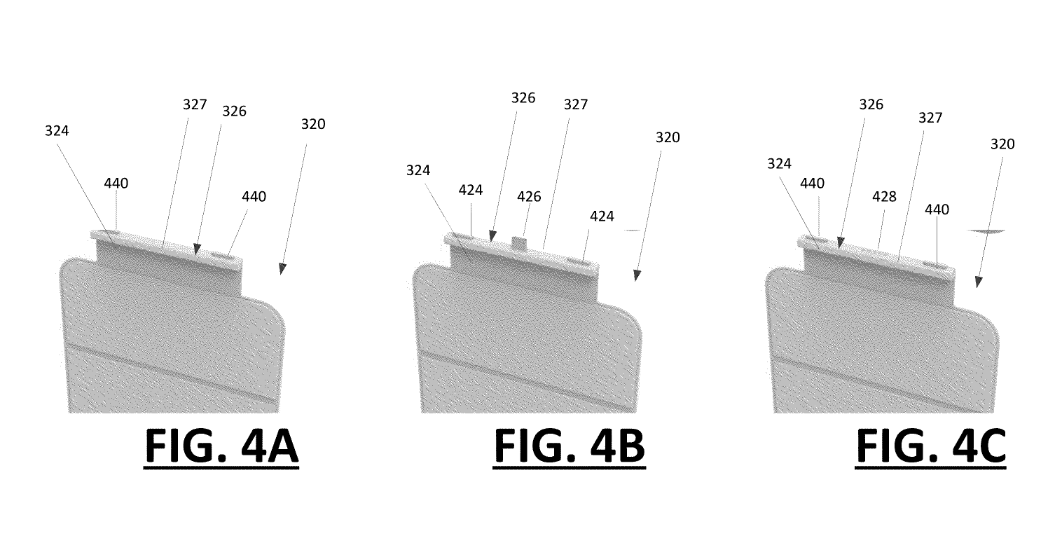

In one implementation, the connector platform 326 can include a connector extension 348 which is shaped and dimensioned to be received by the connector receptacle of the e-reader device 340. In one implementation, connector extension 348 is electrically operational and electrically connects internal components of the cover with those of the e-reader device. For example, the cover 320 can include battery resources, and the connector extension 348 can signal a power signal to a battery recharge subsystem of the e-reader device 340 via the device's connector 346. As an addition or variation to connector extension 348, the connector surface 327 can also include mechanical securement facets, such as magnetic latches, inserts or other mechanisms for facilitating coupling or retention as between the cover 320 and the e-reader device 340. Examples of such facets are shown with examples of FIG. 4A through FIG. 4C.

FIG. 4A through FIG. 4C illustrate different examples of a connector surface for a connector platform of a cover, in accordance with one or more embodiments. For reference, in the examples provided, the cover 320 is shown in a relaxed or unengaged position, with the neck 324 outstretched, and the connector platform 326 is positioned to be oriented outward away from engagement with the e-reader device 340. In an example of FIG. 4A, the connector surface 327 includes mechanical fasteners, such as magnets and/or dimple features. In particular, a pair of magnets 440 are provided on the connector surface 327. In such an implementation, the bottom surface 345 (see FIG. 3B) of the e-reader device 340 can include magnetic attractive material, or alternatively, magnetic material. Such construction can enable the pair of magnets 440 on the connector surface 327 to magnetically couple to the underside of the e-reader device. Facets such as dimples (if present) can provide alignment and/or additional mechanical securement.

With reference to FIG. 4B, the connector surface 327 of the cover 320 can include a combination of protrusions 424 and connector extension 426. As described with an example of FIG. 3A and FIG. 3B, the connector extension 426 can secure into a corresponding connector receptacle of the e-reader device 340. In one implementation, the connector extension 426 is not operational or active, but rather provides mechanical securement by way of its physical insertion into the connector receptacle at the bottom surface 345 of the e-reader device. In a variation, the connector extension 426 can be operational and active, so as to electrically connect to resources of the e-reader device 340. Likewise, the protrusions 424 can engage dimples, recesses or openings of the bottom side 345 of the e-reader device 340 in order to secure the cover 320 and the e-reader device together.

FIG. 4C illustrates an alternative variation for a connector surface. In an example provided, a combination of magnets 440 and/or protrusions can be provided on the connector surface 327 in connection with a data connector. The data connector can be provided by, for example, a set of pogo pins 448 or other passive contact elements. The data connector can be structured to conform to the shape and dimension of the corresponding connector or receptacle on the e-reader device 340.

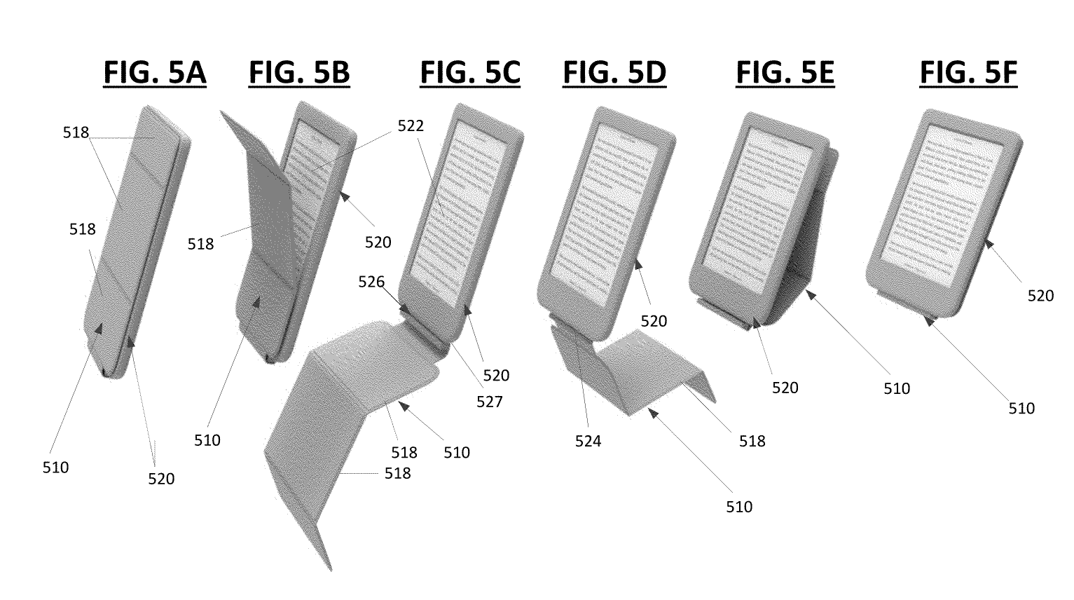

FIG. 5A through FIG. 5F illustrate a cover engaged with a computing device, in accordance with one or more embodiments. In more detail, a cover 510 is shown mechanically coupled to a computing device 520 (e-reader device), with the cover being manipulatable into multiple orientations and configurations. In FIG. 5A, cover 510 is shown in a closed position relative to the computing device 520. In the closed position, the panels 518 are aligned substantially co-planararily and overlay a display surface of the computing device 520. The connector surface 527 (e.g., see FIG. 5C) of the connector platform 526 (e.g., see FIG. 5C) secures the cover 510 to the computing device 520 from the bottom.

FIG. 5B illustrates the cover 510 being peeled back from the display computing device 520 in order to reveal a portion of the display surface. The cover 510 is pinned to the bottom surface of the e-reader device 520 as the covers is separated from the computing device 520.

FIG. 5C illustrates the cover 510 being extended downward to fully expose a display surface 522 of the computing device 520. FIG. 5C shows the connector platform 526 of the cover 510, with the connector surface 527 being in an engaged position and supported by the neck 524. FIG. 5D, FIG. 5E and FIG. 5F each illustrate that the cover 510 can be flipped back beyond the 180 degree mark, to 270 degrees (FIG. 5D) or beyond (e.g., almost 360 degrees as shown in FIG. 5E and FIG. 5F). The cover 510 can maintain physical and/or electrical connection with the computing device 520 while being flipped back.

In some implementations, the cover 510 includes sensors or electronics to detect information about a relative configuration or position. The information can be communicated to the computing device 520 through, for example, an electrical connection formed by the connector extension 428 (see FIG. 4A) and the connector receptacle of the computing device 520.

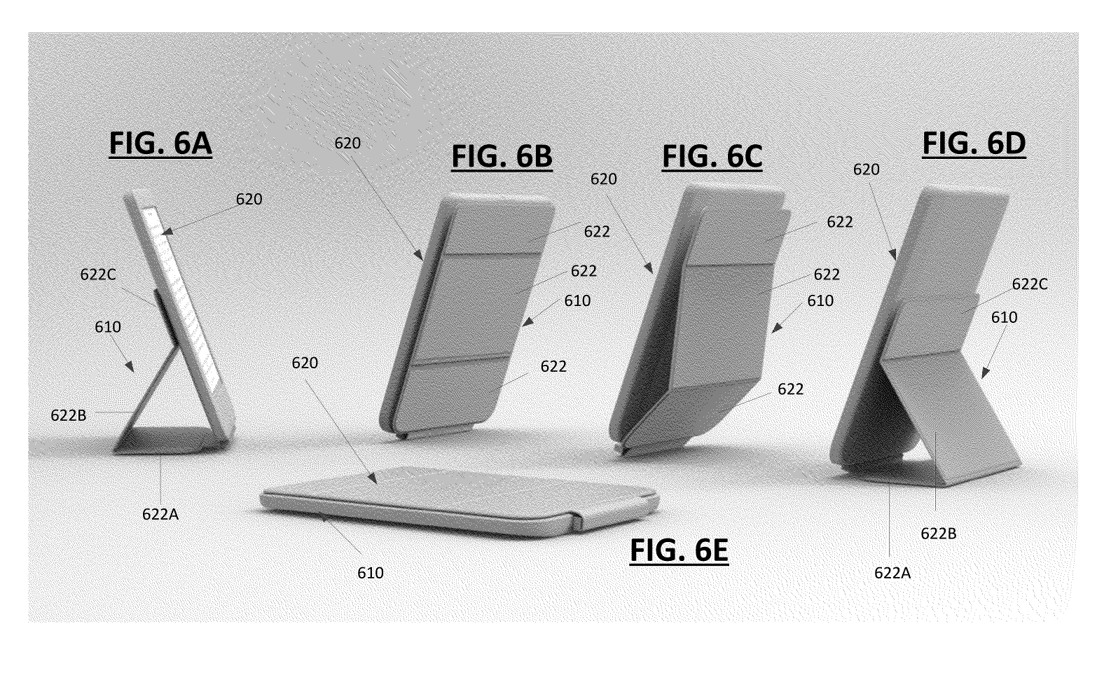

FIG. 6A and FIG. 6B illustrate rear and side perspectives of an example cover that is coupled to a computing device (e.g., e-reader device), in accordance with one or more embodiments. In particular, a cover 610 is shown to be comprised of multiple pivotable panels which can form alternative configurations for supporting the computing device in an upright, or partially upright position.

A cover 610 is coupled to support the computing device 620 in a partially upright position (e.g., position suitable for reading). The support for retaining the computing device 620 is achieved in part through manipulation of the panels 622. The cover 610 includes multiple panels 622, including a first panel 622A which extends from a neck (not shown in FIG. 6A). The first panel 622A can be used to form a base against the underlying surface on which the computing device 620 and cover 610 rest. A second panel 622B extends in a partially upright direction from the first panel 622A, to abut a back surface of the computing device 620. A third panel 622C supports the back surface of the computing device 620 against the base formed by the first panel 622A and the second panel 622B.

FIG. 6C through FIG. 6E illustrate the cover 610 being manipulated so that the panels 622 are aligned linearly along the back face of the computing device 620. As shown, the individual panels can pivot about one another, and further the first panel 622A can pivot about the bottom surface of the computing device 620. This movement allows the cover 610 to have multiple configurations, including different supportive configurations for positioning the computing device 620. Further, the moveability of the panels 622 enables the cover to flip from overlaying or covering a front fagade of the computing device 620 to abutting a back fagade of the computing device 620.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A cover for a computing device, the cover comprising:
a base segment to support the computing device;
a connector platform that mechanically attaches to a bottom surface of the computing device; and
a neck that extends between the base segment and the connector platform, the neck providing the connector platform with an ability to pivot about the bottom surface.

2. The cover of claim 1, wherein the base segment includes multiple panels, each panel being pivotable about an adjacent panel.

3. The cover of claim 1, wherein the connector platform includes an insertive connector extension that inserts into a receptacle connector of the computing device.

4. The cover of claim 3, further comprising one or more electrical resources, and wherein the insertive connector extension mates with the receptacle connector to electrically mate the one or more electrical resources with the computing device.

5. The cover of claim 3, wherein the insertive connector extension is electrically non-functional.

6. The cover of claim 1, wherein the connector platform includes a magnetic coupling mechanism.

7. The cover of claim 1, wherein the connector platform includes protrusions which insert into openings provided with the computing device.

8. The cover of claim 1, wherein the connector platform includes a set of data elements which passively mate with a corresponding set of elements on the computing device.

9. The cover of claim 1, wherein the neck enables the connector platform to pivot up to at least 180 degrees.

10. The cover of claim 1, wherein the neck enables the connector platform to pivot up to about 360 degrees.

11. The cover of claim 1, wherein the neck is formed from flexible material.

12. An assembly comprising:
a computing device having a display surface, a front and back facade, and a surface extending between the front and back facade;
a base segment to support the computing device;
a connector platform that mechanically attaches to a surface of the computing device; and
a neck that extends between the base segment and the connector platform, the neck providing the connector platform with an ability to pivot about the surface.

13. The assembly of claim 12, wherein the base segment includes multiple panels, each panel being pivotable about an adjacent panel.

14. The assembly of claim 12, wherein the connector platform includes an insertive connector extension that inserts into a receptacle connector of the computing device.

15. The assembly of claim 14, further comprising one or more electrical resources retained within the base segment, and wherein the insertive connector extension mates with the receptacle connector to electrically mate the one or more electrical resources with the computing device.

16. The assembly of claim 14, wherein the insertive connector extension is electrically non-functional.

17. The assembly of claim 12, wherein the connector platform includes a magnetic coupling mechanism.

18. The assembly of claim 12, wherein the connector platform includes protrusions which insert into openings provided with the computing device.

19. The assembly of claim 12, wherein the connector platform includes a set of data elements which passively mate with a corresponding set of elements on the computing device.

20. The assembly of claim 12, wherein the neck enables the connector platform to pivot up to at least 180 degrees.
